(19) United States
(12) Patent Application Publication
(10) Pub. No.: US 2008/0054524 A1
(43) Pub. Date: Mar. 6, 2008

(54) Tool, apparatus, and method for reporting a trimmed finish portion of a plastic container

(75) Inventors: Brian J. Chisholm, Sylvania, OH (US); John W. Tobias, Spartansburg, SC (US); Robert J. Stoolmaker, York, PA (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: Graham Packaging Company, L.P., York, PA (US)

(21) Appl. No.: 11/511,381

(22) Filed: Aug. 29, 2006

(51) Int. Cl. B29C 43/02

(52) U.S. Cl. 264/320; 425/387.1; 425/326.1

(57) ABSTRACT

A tool, an apparatus, and a method are provided for reforming a portion of a plastic container such as, for example, a trimmed neck finish end portion of an extrusion blow molded plastic container, after molding and trimming, to eliminate or reduce sharp edges on an inner end surface of the finish end portion. The tool includes a heated portion, a substantially unheated portion, and an insulating portion disposed between the heated portion and the unheated portion. The heated portion has a higher temperature than the unheated portion and is configured to contact and heat the finish portion to at least a glass transition temperature of the plastic container. The unheated portion is also configured to contact the finish portion of the container. The tool is tapered along a longitudinal axis defined by the tool.

### BACKGROUND OF THE INVENTION

1. Field of the Invention

A tool, apparatus, and method are provided for reforming a portion of a plastic container, after molding and trimming, to remove sharp edges thereon, and more particularly to a tool, apparatus, and method for reforming an inner end surface of a finish portion of an extrusion blow molded plastic container, after molding and trimming, to eliminate or reorient sharp edges thereon.

2. Related Art

The process of extrusion blow molding plastic containers typically involves the steps of extruding a tube of monolayer or multilayer plastic material, capturing the tube between opposed mold sections, blowing the tube to the contours of the mold cavity, opening the mold, removing the container, and trimming the end surface of the container neck finish. This trimming operation can involve removal of a flash or moil from the neck finish. The trimmed material may be scrapped or, alternatively, recycled as process regrind. In another exemplary extrusion blow molding operation, the trimming operation can involve separation of two containers that are molded end-to-end. In either case, the trimming operation can leave an uneven or jagged end surface. This can affect later sealing engagement with a container closure and can also have deleterious effects on products deposited in, or withdrawn from, the container. Furthermore, the end surface of the container neck finish may have sharp mold parting line seams that can cause discomfort and/or potential injury to end consumers. These uneven or inconsistent end surface features can also affect induction sealing. Induction sealing can typically involve induction welding a metallic liner disk to a container end surface after filling the container to obtain a satisfactory container seal.

In order to correct these disadvantages, it has been proposed to burnish the end surface of the container neck finish by contacting the neck finish end surface with a heated burnishing tool. Upon contacting the container neck finish end surface, the tool simultaneously heats the end portion of the neck finish to a particular softening temperature of the plastic material and modifies the end surface to eliminate mold parting line seams, uneven trim portions and other post-molding imperfections. This process, however, has certain disadvantages. For example, the heated plastic of the container neck finish may tend to stick to the heated burnishing tool. It is also difficult to control the temperature of the burnishing tool so as to obtain a desired temperature at the burnishing surface of the tool. Moreover, effective burnishing often requires that one of the bottle or the burnishing tool be rotated relative to the other to achieve a desired effect. This introduces additional process variables and, consequently, affects production speed. Thus, the tendency of the heated plastic to stick to the burnishing tool, in combination with the oft-required rotational step and difficulty of controlling the burnishing surface temperature of the tool, makes it difficult to determine and control the optimum tool-to-surface contact time (i.e., dwell time). The dwell time, during which the burnishing tool is in contact with the end portion of the neck finish, as well as additional process variables, should be minimized to achieve the desired surface finish quality and high production speeds.

### SUMMARY OF THE INVENTION

In an exemplary embodiment of the present invention, a tool, an apparatus, and a method are provided for reforming a portion of a plastic container such as, for example, a trimmed neck finish end portion of an extrusion blow molded plastic container, after molding and trimming, to eliminate or reduce sharp edges on an inner end surface of the finish end portion.

In one exemplary embodiment, a tool for reforming a trimmed finish portion of a plastic container is provided and includes a heated portion, a substantially unheated portion, and an insulating portion disposed between the heated portion and the unheated portion. The heated portion has a higher temperature than the unheated portion and is configured to contact and heat the finish portion to at least a glass transition temperature of the plastic container. The unheated portion is also configured to contact the finish portion of the container. The tool is tapered along a longitudinal axis defined by the tool. The tool may, for example, be tapered along a longitudinal axis from the unheated portion to the heated portion. The tapered tool may be arranged to be inserted into the trimmed finish portion of the plastic container in an insertion direction and the heated portion may be adapted to heat and soften the trimmed finish portion such that it can be reformed by further movement of the tool relative to the container in the insertion direction to remove uneven or sharp edges thereon. Thereafter, the unheated portion is adapted to contact and cool the heated trimmed finish portion. The unheated portion may include an outer radiused section arranged to contact the heated trimmed finish portion to provide a rounded surface finish thereto.

An apparatus for reforming a trimmed finish portion of a plastic container is also provided in another exemplary embodiment. The apparatus includes the above-described tool arranged to be introduced into the trimmed finish portion of the plastic container in an insertion direction parallel to the longitudinal axis of the tool. The apparatus may further include a support collar arranged to contact an outer surface of the finish portion of the container to prevent distortion of the finish portion during insertion of the tool therein.

A method for reforming a trimmed finish portion of a plastic container is also provided in yet another exemplary embodiment. The method includes the steps of providing the above-described tool and inserting the tool into the trimmed finish portion of the plastic container along an insertion direction, the insertion direction being parallel to the longitudinal axis of the tool. The method further includes the steps of contacting the trimmed finish portion of the plastic container with the heated portion of the tool to heat the trimmed finish portion to at least a glass transition temperature of the plastic container, and contacting the trimmed finish portion of the plastic container with the unheated portion of the tool. The method may further include the step of contacting the outer surface of the finish portion of the container with the support collar.

Further objectives and advantages, as well as the structure and function of exemplary embodiments will become apparent from a consideration of the description, drawings, and examples.

### BRIEF DESCRIPTION OF THE DRAWINGS

The foregoing and other features and advantages of the invention will be apparent from the following, more particular description of exemplary embodiments of the invention, as illustrated in the accompanying drawings wherein like reference numbers generally indicate identical, functionally similar, and/or structurally similar elements.

FIG. 1 depicts a side cross-sectional view of the tapered reforming tool during insertion into the trimmed finish portion of the plastic container in accordance with an exemplary embodiment of the present invention;

FIG. 2 depicts a side cross-sectional view of the tool shown in FIG. 1 as the heated portion of the tool contacts and deforms the trimmed finish portion of the plastic container;

FIG. 3 depicts a detailed side cross-sectional view of the tool shown in FIG. 2 as the heated portion of the tool contacts and deforms the trimmed finish portion of the plastic container;

FIG. 4 depicts a side cross-sectional view of the tool shown in FIGS. 1 & 2 as the unheated portion of the tool contacts and cools the trimmed finish portion of the plastic container;

FIG. 5 depicts a detailed side cross-sectional view of the tool shown in FIG. 4 as the unheated portion of the tool contacts and cools the trimmed finish portion of the plastic container; and

FIG. 6 is the same as FIG. 1 except that it additionally shows a side cross-sectional view of a support collar contacting an outer surface of the finish portion of the container.

### DETAILED DESCRIPTION OF SEVERAL EMBODIMENTS OF THE INVENTION

Exemplary embodiments of the invention are discussed in detail below. In describing embodiments, specific terminology is employed for the sake of clarity. However, the invention is not intended to be limited to the specific terminology so selected. While specific exemplary embodiments are discussed, it should be understood that this is done for illustration purposes only. A person skilled in the relevant art will recognize that other components and configurations can be used without parting from the spirit and scope of the invention. All references cited herein are incorporated by reference as if each had been individually incorporated.

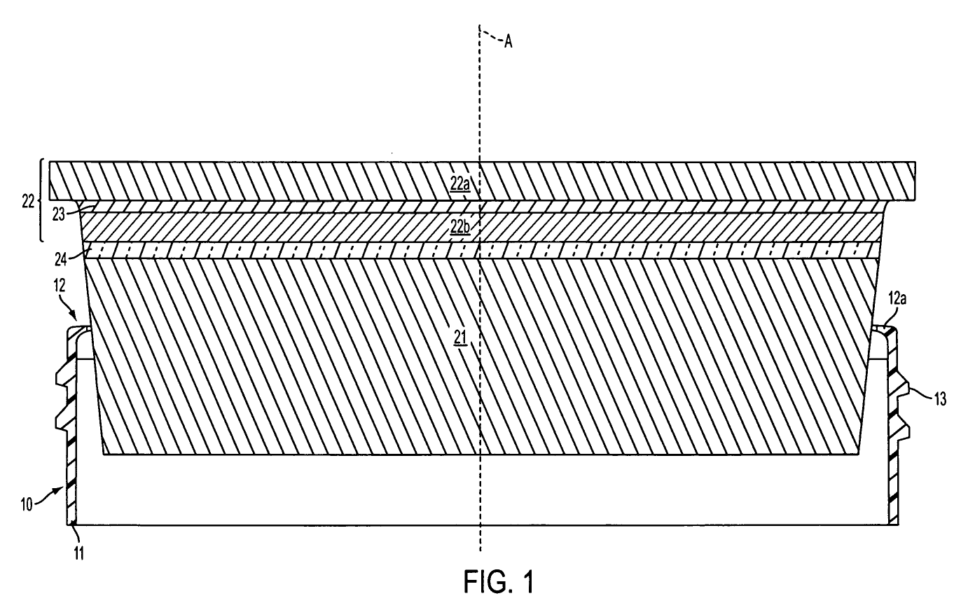

FIGS. 1-6 illustrate a tool, an apparatus, and a method for reforming a trimmed finish portion of a plastic container such as, for example, an inner end surface of a neck finish of a plastic container in accordance with an exemplary embodiment of the present invention. Referring to FIG. 1, a plastic container 10 includes a neck finish 11 with a trimmed end portion 12 that may include a radially inwardly and axially upwardly extending flange 12a. (Directional words such as “upwardly” and “downwardly” are employed by way of description and not limitation with respect to the orientation of the apparatus and the containers illustrated in the drawings. Directional words such as “axial” and “radial” are employed by way of description and not limitation with respect to a longitudinal axis of the container finish or the reforming tool as appropriate.) Flange 12a may be formed by a trimming operation after extrusion blow molding, for example, in which container 10 is severed from a moil or flash. The neck finish 11 of container 10 may also include external threads 13 on an outer surface thereof for engagement by a closure (not shown) such as, for example, a screw-on cap. Other types of closures may also be used such as, for example, snap-on closures. The neck finish 11, thus, may include threads 13 or other external features for receiving a closure depending on the type of closure desired.

With reference to FIGS. 1-3, a tool 20 may be provided for reforming flange 12a of the trimmed finish portion 12 of plastic container 10. The tool 20 defines a longitudinal axis A and may be arranged to be inserted into an opening defined by the neck finish 11 of plastic container 10. The tool 20 may include a heated portion 21 at a first end of the tool 20, a substantially unheated portion 22 at a second end of the tool 20 opposite the first end, and an insulating portion 24 disposed longitudinally between the heated portion 21 and the unheated portion 22. Furthermore, the tool 20 may be tapered along the longitudinal axis A. Specifically, the tool 20 may taper substantially inwardly toward the longitudinal axis A from the unheated portion 22 to the heated portion 21 so as to form a frustoconical outer annular surface. Although the tool 20 shown in the present embodiment has a circular cross-sectional shape, the tool 20 may also have other cross-sectional shapes including, for example, rectilinear and elliptical cross-sectional shapes depending on the shape of the neck-finish into which the tool 20 is to be plunged.

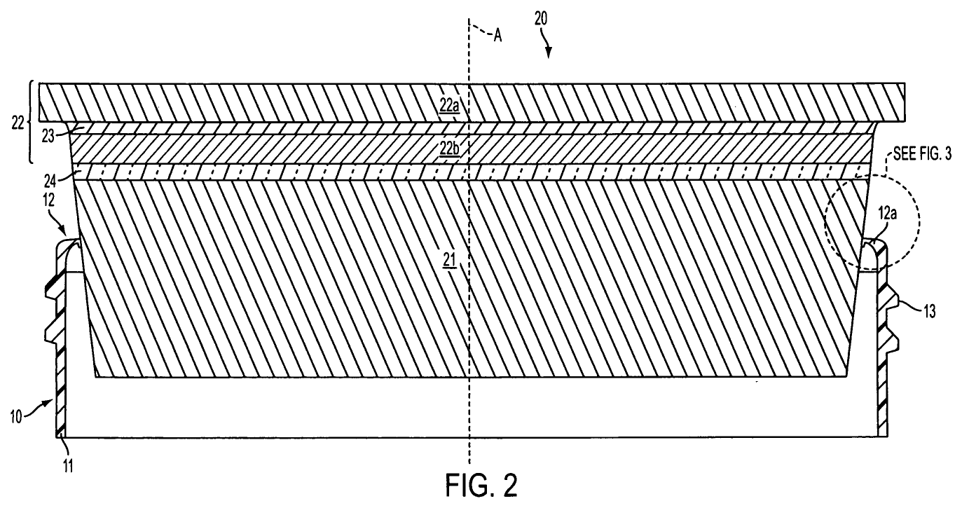

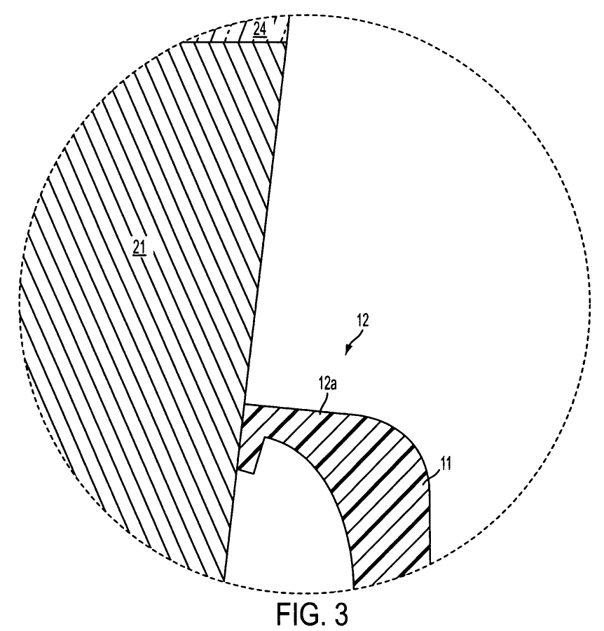

The heated portion 21 may, for example, have a higher temperature than the unheated portion 22. The surface temperature of the heated portion 21 may be, for example, sufficient to heat the flange 12a of the trimmed finish portion 12 to a softening temperature, for example, a glass transition temperature, of the plastic upon contact therewith to soften the plastic and allow the reformation thereof (see FIGS. 2 and 3). The heated portion 21 may be heated in various ways such as, for example, electrical resistance heating or hot liquid circulation (e.g., water or oil) (not shown). The unheated portion 22 may be insulated from any positive heat source and/or actively cooled by a cooling system (not shown) such as, for example, a cooled air- or water-circulation system. The cooling system should be sufficient to offset any heat transferred from the heated portion 21 of the tool 20. The heated and unheated portions 21, 22, may be formed from the same or different materials, for example, Ampco® Bronze, Beryllium/Copper (BeCu) alloys, stainless steel, and aluminum. Furthermore, the insulating portion 24 may be formed from a number of insulating materials such as, for example, Teflon®, nylon or other thermoplastic material, a composite material, PTFE, fiber, phenolic, and/or ceramic. The insulating material of the insulating portion 24 may be machinable. The outer surfaces of each of the heated portion 21, the insulating portion 24, and the unheated portion 22 may include various coatings thereon to improve lubricity and wear of the tool 20.

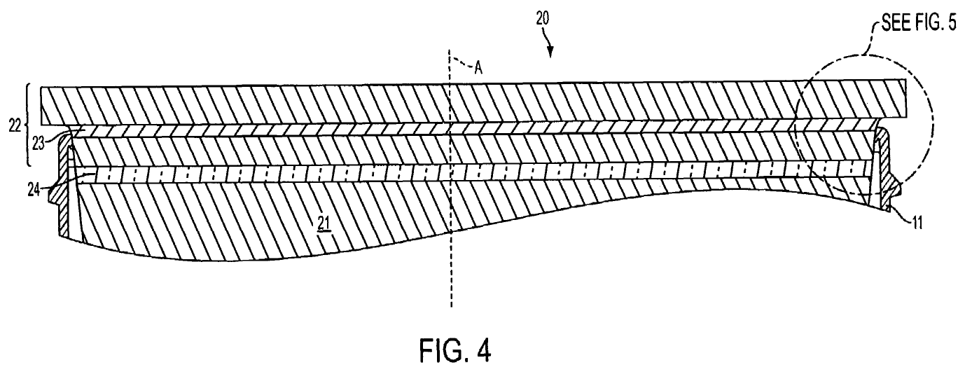

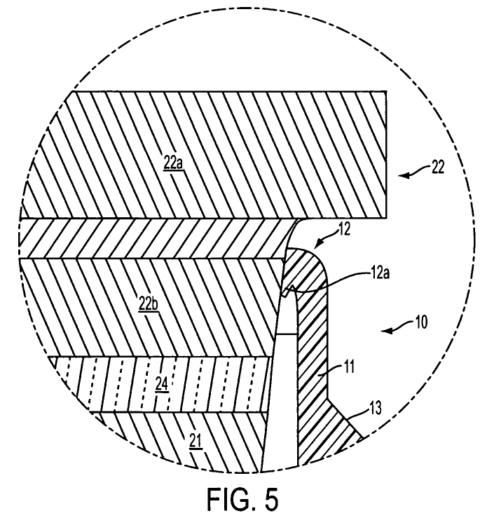

With further reference to FIGS. 1-5, especially FIGS. 4 and 5, the unheated portion 22 of the tool 20 can include a first section 22a, a second section 22b disposed adjacent to the insulating portion 24, and an outer radiused section 23 arranged between the first section 22a and the second section 22b. In the embodiment shown, the first section 22a is cylindrical and the second section 22b is tapered along the longitudinal axis away from the first section 22a towards the heated portion 21. The outer radiused section 23 is configured to contact and cool the flange 12a of the trimmed finish portion 12 when the tool 20 is fully inserted into the finish portion 12. The outer radiused section 23 can have a concave curvature of any size depending on the desired final shape of the reformed finish portion 12. Other shapes and configurations are also possible for the outer radiused section 23 depending on the desired final shape of the reformed finish portion 12.

In use, as shown in FIGS. 1-5, the tool 20 is positioned such that the longitudinal axis A of the tool 20 is aligned with a central longitudinal axis of the neck finish 11 of container 10 after a moil or flash is trimmed from neck finish 11 at the conclusion of an extrusion blow molding process, for example. The tool 20 is arranged to be inserted or plunged in an insertion direction into the opening defined by the neck finish 11 (see FIG. 1). The insertion direction is parallel to the longitudinal axis of the tool 20. Upon insertion, the heated portion 21 of the tool 20 makes contact with the trimmed finish portion 12 of neck finish 11, in particular with flange 12a, and heats the trimmed finish portion 12 to substantially its glass transition temperature so as to soften the trimmed finish portion and allow the reforming thereof (see FIGS. 2 and 3). The tool 20 is then inserted farther into the neck finish 11 until the unheated portion 22 contacts the trimmed finish portion 12 so as to cool the trimmed finish portion 12 below the glass transition temperature and thereby set the reformed shape of the trimmed finish portion 12 (see FIGS. 4 and 5). Once the trimmed finish portion is sufficiently cooled, the tool 20 is removed by moving in a direction substantially opposite to the insertion direction. As a result, at least a portion of the trimmed finish portion 12 takes the shape of the outer radiused section 23 of the tool 20. This leaves the trimmed finish portion 12 of the neck finish 11 free of features that can deleteriously affect the ability to seal the container 10, such as mold parting lines, mismatch seams, nicks and other manufacturing imperfections created, for example, in the production and trimming process. Insertion and removal of the tool 20 may be effected by any known mechanical or electro-mechanical means such as, for example, a cam-driven system and/or an electronically controlled or computerized pneumatic or hydraulic system capable of manipulating the tool 20 along at least one axis.

As shown in FIGS. 1-5, a method for reforming the trimmed finish portion 12 of a plastic container 10 is also provided. The method includes the steps of providing the above-described tool 20 and inserting the tool 20 into the trimmed finish portion 12 of the plastic container 10 along an insertion direction, the insertion direction being parallel to the longitudinal axis A of the tool (see FIG. 1). The method further includes the steps of contacting the trimmed finish portion 12 of the plastic container 10 with the heated portion 21 of the tool 20 to heat the trimmed finish portion 12 to at least a glass transition temperature of the plastic container 10 (see FIGS. 2 and 3), and contacting the trimmed finish portion 12 of the plastic container 10 with the unheated portion 22 of the tool 20 (see FIGS. 4 and 5). Insertion and removal of tool 20 during the process may be a continuous or substantially continuous motion or, alternatively, an intermittent set of movements and stoppages wherein the tool 20 is, for example, inserted partially into finish portion 12, stopped at a position whereby the flange 12a can be heated by the heated portion 21, and then inserted further into the finish portion 12 before stopping at a position whereby the heated and reformed flange 12a can be cooled by the unheated portion 22 before removal of tool 20. Movement of the tool 20 may be based on one of the foregoing motions or some combination thereof based on desired dwell times of the described tool portions against the finish portion 12 which is dictated by an insertion rate of tool 20, the relative lengths of each portion of the tool 20, and the respective temperatures of each portion of tool 20.

The container 10 may have a one-piece construction and can be prepared from a monolayer plastic material, such as a polyamide, for example, nylon; a polyolefin such as polyethylene, for example, low density polyethylene (LDPE) or high density polyethylene (HDPE), or polypropylene; a polyester such as, for example, polyethylene terephthalate (PET) or polyethylene naphtalate (PEN); or others, which can also include additives to vary the physical or chemical properties of the material. For example, some plastic resins can be modified to improve the oxygen permeability. Alternatively, the container can be prepared from a multilayer plastic material. The layers can be any plastic material, including virgin, recycled and reground material, and can include plastics or other materials with additives to improve physical properties of the container. In addition to the above-mentioned materials, other materials often used in multilayer plastic containers include, for example, ethylvinyl alcohol (EVOH) and tie layers or binders to hold together materials that are subject to delamination when used in adjacent layers. A coating may be applied over the monolayer or multilayer material, for example to introduce oxygen barrier properties. In the exemplary embodiment, the container 10 is prepared from PET. The container 10 of the present invention can be of monolayer plastic construction, or can be of multilayer plastic construction in which intermediate layers may or may not extend into the neck finish end portion of the container.

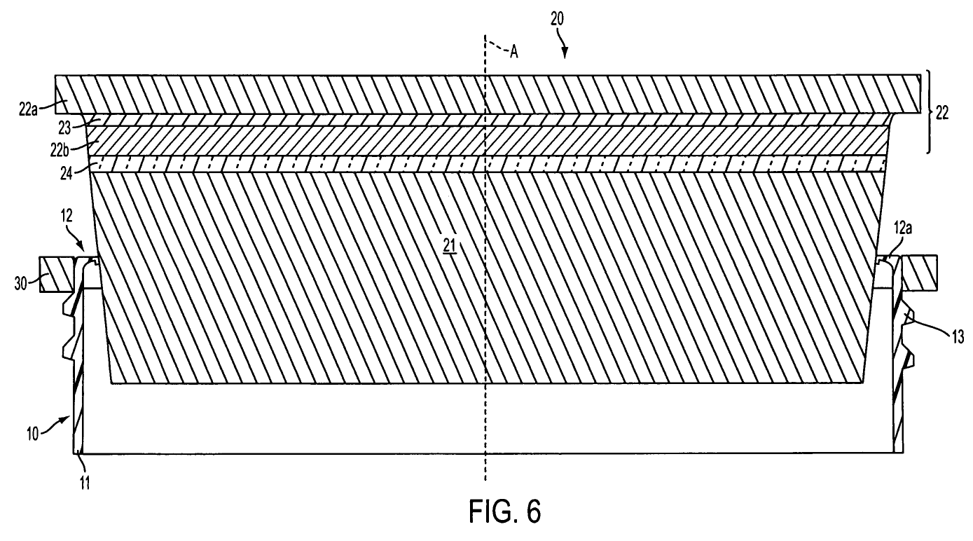

FIG. 6 shows another exemplary embodiment of the apparatus and method of the invention. FIG. 6 is the same as FIG. 1 except that it additionally includes a support collar 30 arranged to contact an outer surface of the neck finish 11 before tool 20 is inserted into the finish portion 12 so as to provide support to the neck finish 11 and prevent distortion of the neck finish 11 during insertion of the tool 20 and reforming of the trimmed finish portion 12. The support collar 30 may be, for example, in the form of a clamp arranged to engage at least a portion of the outer surface of the neck finish 11 to prevent distortion during reforming with tool 20. The support collar 30 may be, for example, a two-part clamp.

There have thus been disclosed a method and an apparatus for reforming a portion of a plastic container such as, for example, a neck finish end surface of the container, and a container having a reformed neck finish end surface. The invention has been disclosed in conjunction with various exemplary embodiments thereof, and a number of modifications and variations have been discussed. Other modifications and variations will readily suggest themselves to persons of ordinary skill in the art. Although the invention has been disclosed in conjunction with reforming the trimmed end of an extrusion blow molded container neck finish, the invention in its broadest aspects can be applied to other portions of a container. For example, the invention in its broadest aspects can be implemented in conjunction with portions of injection or compression molded containers such as neck finishes thereon and/or on portions of containers made in a reheat blow molding operation or an injection/extrusion/blow molding operation. The invention is intended to embrace these and all other modifications and variations that fall within the spirit and broad scope of the appended claims.

1. A tool for reforming a trimmed finish portion of a plastic container, the tool defining a longitudinal axis and comprising:
a heated portion configured to contact and heat the finish portion to at least a glass transition temperature of the plastic container;
a substantially unheated portion configured to contact the finish portion of the container; and
an insulating portion disposed between the heated portion and the unheated portion, wherein the heated portion has a higher surface temperature than the unheated portion and the tool is tapered along the longitudinal axis.

2. The tool according to claim 1, wherein the heated portion is disposed at a first end of the tool and the unheated portion is disposed at a second end of the tool, the first end of the tool being arranged to contact the finish portion of the container before the second end of the tool when the tool is inserted into the finish portion of the container.

3. The tool according to claim 2, wherein the tool tapers inwardly toward the longitudinal axis from the second end to the first end.

4. The tool according to claim 1, wherein the tool defines a frustoconical outer annular surface.

5. The tool according to claim 1, wherein the substantially unheated portion includes:
a first section;
a second section disposed adjacent to the insulated portion; and
an outer radiused section arranged between the first section and the second section.

6. The tool according to claim 5, wherein the first section is cylindrical and the second section is tapered along the longitudinal axis away from the first section towards the heated portion.

7. An apparatus for reforming a trimmed finish portion of a plastic container, the apparatus comprising the tool according to claim 1, the tool being arranged to be introduced into the trimmed finish portion of the plastic container in an insertion direction, wherein the insertion direction and the longitudinal axis of the tool are parallel.

8. The apparatus according to claim 7, further comprising a support collar arranged to contact an outer surface of the finish portion of the container.

9. The apparatus according to claim 7, wherein the tool tapers inwardly along the longitudinal axis from the unheated portion to the heated portion.

10. The apparatus according to claim 7, wherein the tool defines a frustoconical outer annular surface.

11. The apparatus according to claim 7, wherein the unheated portion of the tapered tool includes:
a first section;
a second section disposed adjacent to the insulated portion; and
an outer radiused section arranged between the first section and the second section.

12. The apparatus according to claim 11, wherein the first section is cylindrical and the second section is tapered along the longitudinal axis away from the first section towards the heated portion.

13. A method for reforming a trimmed finish portion of a plastic container, comprising:
providing a tool having a heated portion, a substantially unheated portion, and an insulating portion disposed between the heated portion and the unheated portion, wherein the heated portion has a higher surface temperature than the unheated portion and the tool is tapered along a longitudinal axis from the unheated portion to the heated portion;
inserting the tool into the trimmed finish portion of the plastic container along an insertion direction, the insertion direction being parallel to the longitudinal axis of the tool;
contacting the trimmed finish portion of the plastic container with the heated portion of the tool, whereby the heated portion heats the trimmed finish portion to at least a glass transition temperature of the plastic container; and
contacting the trimmed finish portion of the plastic container with the unheated portion of the tool.

14. The method according to claim 13, further comprising the step of, after contacting the trimmed finish portion of the plastic container with the heated portion of the tool, moving the tool farther into the container in the insertion direction.

15. The method according to claim 13, wherein the unheated portion of the tool includes an outer radiused section, the method further comprising the step of contacting the trimmed finish portion of the plastic container with the outer radiused section of the unheated portion of the tool.

16. The method according to claim 13, further comprising removing the tool from the trimmed finish portion of the plastic container.

17. The method according to claim 13, wherein the plastic container is held stationary and the tool is movable with respect to the plastic container.

18. The method according to claim 13, wherein the tool is held stationary and the plastic container is movable with respect to the tool.

19. The method according to claim 13, wherein the tool and the plastic container are rotationally fixed with respect to one another.

20. The method according to claim 13, further comprising contacting an outer surface of the finish portion of the plastic container with a support collar.
